(19) United States
(12) Patent Application Publication
(10) Pub. No.: US 2017/0297144 A1
(43) Pub. Date: Oct. 19, 2017

(54) LASER BEAM MACHINE AND LASER BEAM MACHINING METHOD

(71) Applicant: MURATA MACHINERY, LTD., Kyoto-shi (JP)

(72) Inventor: Keiichi Nakanishi, Kyoto-shi (JP)

(73) Assignee: MURATA MACHINERY, LTD., Kyoto-shi (JP)

(21) Appl. No.: 15/480,132

(22) Filed: Apr. 5, 2017

(30) Foreign Application Priority Data
Apr. 14, 2016 (JP) 2016-080893
Jan. 18, 2017 (JP) 2017-006573

(51) Int. Cl. B23K 26/03; B23K 26/06; H04N 5/04

(52) U.S. Cl. CPC B23K 26/032; H04N 5/04; B23K 26/0643; B23K 26/0648

(57) ABSTRACT

A laser beam machine includes a laser oscillator that emits a machining laser beam, an irradiation optical system that irradiates a workpiece with a machining laser beam, a laser array that has a plurality of laser elements disposed in an array and emits an illumination laser beam by output of the plurality of laser elements, an illumination optical system that illuminates the workpiece with the illumination laser beam emitted by the laser array, and an imaging unit that images the workpiece which is illuminated by the illumination optical system with the illumination laser beam.

### CROSS-REFERENCE TO RELATED APPLICATIONS

This application claims priority under 35 U.S.C. 119 to Japanese Patent Application No. 2016-080893, filed on Apr. 14, 2016, which application is hereby incorporated by reference in its entirety.

### BACKGROUND OF THE INVENTION

### 1. Field of the Invention

A laser beam machine is used for cutting, welding, and the like of a workpiece. In the laser beam machine, in order to improve machining quality of the workpiece, there is a technique of obtaining a state of machining the workpiece from an image captured during the machining. At this time, following laser beam machining, when strong light emitted from the workpiece (light emission by melting of metal, plasma light following evaporation of the metal, and the like) is incident to a camera as disturbance light, the disturbance light becomes noise on an image, and it becomes difficult to obtain the machining state with high accuracy. Therefore, it is desired that illuminance of an illumination light source of the camera is relatively high as compared with the disturbance light.

However, when the workpiece is illuminated with the illumination light of the illumination light source via an optical system, a loss in an optical path is required to be reduced, by enhancing parallelism (by improving rectilinearity) along an optical path of the optical system. In general, in order to obtain a beam of high parallelism, the illumination light source is required to have a small light emitting area and a small divergence angle. As an illumination light source that satisfies the above condition, a laser light source is considered.

However, because a laser beam is coherent light (light having strong coherence), following reflection from a surface of an optical system (each optical member) or reflection from a surface of the workpiece, interference fringes or speckle patterns may be observed at the time of imaging. The interference fringes or the speckle patterns become noise of a captured image, and may adversely affect obtaining of a machining state. As a technique relevant to this point, there has been proposed a technique of using an incoherent illumination for illumination at the time of imaging the workpiece during the machining. According to the above technique, a laser light source is mentioned as one of light sources that are used for illumination, and superimposing a plurality of different laser beams is mentioned as a method for lowering coherence of a laser beam.

However, according to the above technique, a specific method of superimposing a plurality of laser beams is not discussed. For example, when laser beams from a plurality of laser oscillators are input to an optical fiber and a plurality of optical fibers are mixed in a bundle, a device configuration becomes complex or becomes large, which results in a high device cost. The present invention has been made in view of the above circumstances, and an object thereof is to enable obtaining of a high-quality captured image of a workpiece to be machined with a space-saving configuration.

### BRIEF SUMMARY OF THE INVENTION

A laser beam machine of the present invention includes a laser oscillator that emits a machining laser beam, an irradiation optical system that irradiates a workpiece with the machining laser beam, a laser array that has a plurality of laser elements disposed in an array and emits an illumination laser beam by output of the plurality of laser elements, an illumination optical system that illuminates the workpiece with the illumination laser beam emitted by the laser array, and an imaging unit that images the workpiece which is illuminated by the illumination optical system with the illumination laser beam.

A laser beam machining method of the present invention includes emitting a machining laser beam, irradiating a workpiece with the machining laser beam, emitting an illumination laser beam by output of a plurality of laser elements from a laser array in which the plurality of laser elements are disposed in an array, illuminating the workpiece with the illumination laser beam emitted by the laser array, and imaging the workpiece illuminated with the illumination laser beam.

According to the present invention, a laser array that has a plurality of laser elements disposed in an array is used as an illumination light source. Therefore, coherence of illumination light becomes low, inclusion of a speckle pattern and the like in a captured image can be suppressed, and the illumination light source can be configured compact. Further, with the beam having high parallelism as an advantage of a laser light source, a loss in an optical path can be suppressed, and sufficient illuminance can be secured on a workpiece surface. Therefore, a high-quality captured image of a workpiece to be machined can be obtained with a space-saving configuration.

Further, the present invention is desirably configured as follows. That is, in the laser array, a plurality of laser elements are arranged two dimensionally. Accordingly, illumination can be achieved in a range with a planar spread.

Further, the present invention is desirably configured as follows. That is, in the laser array, each of the plurality of laser elements is a vertical cavity surface emitting laser element. Accordingly, because vertical cavity surface emitting laser elements can be arrayed in high density, the workpiece can be illuminated by high illuminance while saving space, so that a high-quality captured image can be obtained.

Further, the present invention is desirably configured as follows. That is, the laser array is disposed at a position where a focal point of the illumination laser beam is at a position different from a position of the workpiece surface, the illumination laser beam being emitted by the laser array and having passed through the illumination optical system. Accordingly, a spot of a laser beam from each of the plurality of laser elements is spread by defocus, and a part of the spot is overlapped with an adjacent spot so that uniformity of illuminance is improved.

Further, the present invention may be configured as follows. That is, the laser beam machine further includes a nozzle provided with an emission port for emitting the illumination laser beam via the illumination optical system. The laser array is disposed in a state where the focal point is positioned on a nozzle side with respect to a workpiece surface. In addition, the present invention is desirably configured as follows. That is, the laser beam machine further includes a machining head including the nozzle. The laser array is disposed at a position where the focal point is located inside the machining head. Accordingly, a distance relationship between a workpiece surface supported by a predetermined supporting base and the nozzle changes depending on a machining condition or the like of the workpiece. However, because the focal point is located inside the machining head, defocusing can be reliably performed from the workpiece surface.

Further, the present invention is desirably configured as follows. That is, the laser beam machine includes a position change part adapted to change a relative positional relationship between the laser array and the illumination optical system, in an optical axis direction of the illumination optical system. Accordingly, because a defocusing amount can be adjusted, uniformity of illuminance at the focal point of the illumination optical system can be adjusted.

Further, the present invention is desirably configured as follows. That is, the illumination optical system includes a collimator to which the illumination laser beam is incident from the laser array, and a condensing lens to which the illumination laser beam is incident from the collimator. The position change part is adapted to change a relative positional relationship between the laser array and the collimator. Accordingly, because a defocusing amount can be adjusted by relative movement of the laser array and the collimator, the defocusing amount can be adjusted independently of a position of the condensing lens, for example.

Further, the present invention is desirably configured as follows. That is, the laser beam machine includes a diffusion member that is disposed in an optical path between the laser array and the workpiece. Accordingly, the laser beam from each of the plurality of laser elements can be spread by the diffusion member. At the focal point of the illumination optical system, a part of the spot of the laser beam from the laser element is overlapped with an adjacent spot, so that uniformity of illuminance improves.

Further, the present invention is desirably configured as follows. That is, the diffusion member is disposed in an optical path between the laser array and the illumination optical system. Accordingly, because the diffusion member is disposed on an incidence side with respect to the illumination optical system, it is possible to avoid interference between an optical path of the machining laser beam or an optical path of light directed from the workpiece toward the imaging unit, and the diffusion member, for example.

Further, the present invention is desirably configured as follows. That is, the laser beam machine includes a diaphragm member disposed in an optical path between the diffusion member and the illumination optical system. Accordingly, part of the illumination laser beam which is spread by the diffusion member can be blocked by the diaphragm member, and generation of stray light by the spread illumination laser beam can be suppressed.

Further, the present invention is desirably configured as follows. That is, the laser beam machine includes a driving unit that drives the laser array, and a heat dissipation member that is in contact with the laser array. Accordingly, the heat dissipation member can be shared by the driving unit and the laser array. For example, it is possible to reduce the number of parts, and dispose the driving unit and the laser array while saving space.

Further, the present invention is desirably configured as follows. That is, the driving unit and the laser array are disposed so as to sandwich the heat dissipation member, and are electrically connected to each other by a wire that passes through a hole penetrating through the heat dissipation member. Accordingly, the wire between the driving unit and the laser array can be shortened. For example, a loss of power by the wire can be reduced.

Further, the present invention is desirably configured as follows. That is, the laser array is pulse driven, and the imaging unit executes imaging synchronously with pulse drive of the laser array. Accordingly, as compared with a case where the laser array continuously oscillates, power consumption and a heating value by the laser array can be reduced, for example. Further, while maintaining the power consumption and the heating value by the laser array, illuminance on the workpiece can be also improved by increasing a driving current of the laser array. Further, a time during which the imaging unit receives the light from the workpiece in imaging one frame becomes short, so that a blur generated when the workpiece and the imaging unit relatively move can be reduced.

Further, the present invention is desirably configured as follows. That is, the laser beam machine includes a machining head that stores therein the irradiation optical system, and an illuminating unit that stores therein the laser array and the illumination optical system. The illuminating unit is detachably connected to the machining head. Accordingly, the illuminating unit can be replaced in accordance with aged deterioration or an illumination condition, for example. Further, by using the laser array configured by a plurality of vertical cavity surface emitting laser elements, the illuminating unit can be made more compact or light weight, so that the illuminating unit can be easily detached.

Further, the present invention is desirably configured as follows. That is, the laser beam machine includes a nozzle provided with an emission port for emitting the illumination laser beam via the illumination optical system and emitting the machining laser beam via the irradiation optical system. The laser array and the illumination optical system are configured such that a projection region of the laser array defined by a size of the laser array and optical magnification of the illumination optical system includes an emission port region of the nozzle. Accordingly, even when an optical axis of the illumination laser beam and an optical axis of the machining laser beam are displaced because of a positional displacement of the laser array, the illumination optical system, or the irradiation optical system, for example, a desired observation position of the workpiece can be illuminated with the illumination laser beam.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a laser beam machine according to a first embodiment;

FIGS. 2A and 2B are diagrams illustrating a laser array and a vertical cavity surface emitting laser element;

FIGS. 3A and 3B are explanatory diagrams concerning optical magnification of an illumination optical system;

FIG. 4 is a diagram illustrating a characteristic of a wavelength selection filter;

FIGS. 5A and 5B are diagrams illustrating the laser array, a part of the illumination optical system, and a heat dissipation member according to the first embodiment;

FIG. 6 is a sequence diagram illustrating operations of a controller and an image processor;

FIGS. 7A and 7B are diagrams illustrating a laser array, a part of an illumination optical system, and a heat dissipation member according to a second embodiment;

FIG. 8 is a diagram illustrating a laser array, a part of an illumination optical system, and a heat dissipation member according to a third embodiment; and

FIG. 9 is a diagram illustrating a focal point of an illumination laser beam according to a fourth embodiment.

### DETAILED DESCRIPTION OF PREFERRED EMBODIMENTS

Hereinafter, embodiments will be described with reference to the drawings. In each of the following figures, directions in the figure will be described by using an XYZ coordinate system. In the XYZ coordinate system, a vertical direction will be described as a Z direction, and horizontal directions will be described as an X direction and a Y direction. Further, in each direction (e.g., the X direction), a direction of an arrow will be referred to as a +side (e.g., a +X side), and an opposite side will be referred to as a −side (e.g., a −X side).

### First Embodiment

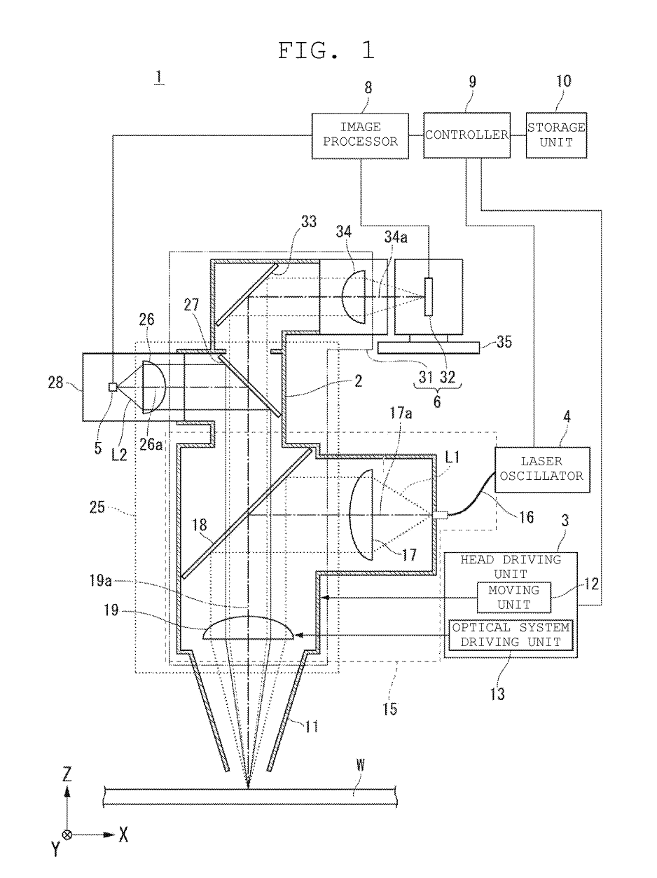

FIG. 1 is a diagram illustrating a laser beam machine 1 according to the present embodiment. The laser beam machine 1 includes a machining head 2, a head driving unit 3, a laser oscillator 4, a laser array 5, an imaging unit 6, an image processor 8, a controller 9, and a storage unit 10. The laser beam machine 1 carries out cutting to a workpiece W by numerical control, for example. The controller 9 comprehensively controls each part of the laser beam machine 1, following a numerical control program, for example.

The machining head 2 has a nozzle 11. A machining laser beam L1 and an illumination laser beam L2 are radiated on the workpiece W through an inside of an emission port (a through-hole penetrating through the nozzle 11) formed on the nozzle 11. The machining head 2 is provided to be able to move relative to the workpiece W, in each of the X direction, the Y direction, and the Z direction. The head driving unit 3 includes a moving unit 12 and an optical system driving unit 13. The head driving unit 3 is controlled by the controller 9, and moves the machining head 2 in each of the X direction, the Y direction, and the Z direction by the moving unit 12. Further, the head driving unit 3 is controlled by the controller 9, and adjusts a focal point of light irradiated from the nozzle 11, by the optical system driving unit 13. The laser beam machine 1 carries out cutting by irradiating the workpiece W with the machining laser beam L1 from the nozzle 11 of the machining head 2, while moving the machining head 2 relative to the workpiece W.

The laser oscillator 4 generates an infrared laser beam, for example, as the machining laser beam L1. An irradiation optical system 15 is provided inside the machining head 2. The irradiation optical system 15 guides the machining laser beam L1 generated by the laser oscillator 4 toward the workpiece W, and radiates the workpiece W through the emission port of the nozzle 11. The irradiation optical system 15 includes an optical fiber 16, a collimator 17, a beam splitter 18, and a condensing lens 19. The optical fiber 16 has one end (an end part on a light incidence side) connected to the laser oscillator 4, and the other end (an end part on a light emission side) connected to the machining head 2. The machining laser beam L1 from the laser oscillator 4 is guided to the machining head 2 via the optical fiber 16.

The collimator 17 converts the machining laser beam L1 from the laser oscillator 4 into parallel light, or brings the machining laser beam L1 close to parallel light. The collimator 17 is disposed so that a focal point (an illumination-side focal point described later) on an object side (the light incidence side) of the collimator 17 coincides with a position of the end part on the light emission side of the optical fiber 16, for example. The beam splitter 18 is disposed at a position where the machining laser beam L1 having passed through the collimator 17 is incident. The beam splitter 18 is a wavelength selection mirror (e.g., a dichroic mirror) that has a characteristic of reflecting the machining laser beam L1 and transmitting the illumination laser beam L2 (described later). The beam splitter 18 is inclined at an angle of about 45° to an optical axis 17a of the collimator 17. The beam splitter 18 is inclined toward the +X side as the beam splitter 18 is directed toward the +Z side.

The condensing lens 19 is disposed at a position where the machining laser beam L1 from the beam splitter 18 is incident. The machining laser beam L1 having passed through the collimator 17 is reflected by the beam splitter 18, and an optical path is bent by about 90° from the X direction to the Z direction (a −Z side), so that the machining laser beam L1 is incident to the condensing lens 19. The condensing lens 19 condenses the machining laser beam L1 from the collimator 17. When the optical system driving unit 13 of the head driving unit 3 moves the condensing lens 19 along an optical axis 19a of the condensing lens 19, for example, the head driving unit 3 can adjust a focal point (a workpiece-side focal point described later) on a workpiece side of the irradiation optical system 15. A spot diameter of the machining laser beam L1 on a surface of the workpiece W becomes larger as a focal point of the irradiation optical system 15 is further separated from the surface of the workpiece W (when a defocusing amount becomes larger).

When the spot diameter of the machining laser beam L1 on the surface of the workpiece W changes, a width of a cutting groove (a kerf width, a cutting width) on the workpiece W formed by the machining laser beam L1 changes.

The laser beam machine 1 according to the embodiment can obtain information concerning a machining state, by imaging the workpiece W while illuminating the workpiece W with the illumination laser beam L2. The laser array 5 emits, as the illumination laser beam L2, light having a wavelength different from a wavelength of the machining laser beam L1. Further, the laser array 5 is configured as an illuminating unit 28 (stored in a casing of the illuminating unit 28), together with a part of an illumination optical system 25 described later (a collimator 26 and the like). The illuminating unit 28 is detachably connected to the machining head 2. Accordingly, when the illuminating unit 28 is connected to the machining head 2, a burden of carrying the illuminating unit 28 is reduced, because the illuminating unit 28 has a unit configuration including an illumination light source (the laser array 5) with reduced weight as compared with a conventional semiconductor laser.

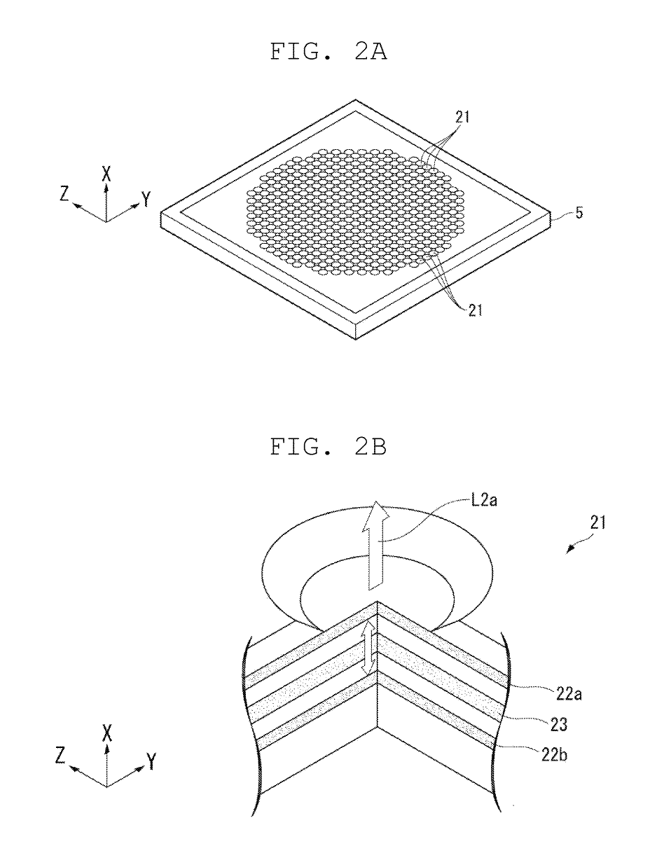

FIG. 2A is a diagram illustrating appearance of the laser array 5, and FIG. 2B is a diagram schematically illustrating a structure of a vertical cavity surface emitting laser element. As illustrated in FIG. 2A, the laser array 5 includes a plurality of vertical cavity surface emitting laser elements (hereinafter, referred to as VCSELs), and emits the illumination laser beam L2 by output of the plurality of vertical cavity surface emitting laser elements. A plurality of VCSELs 21 are two-dimensionally disposed on a substrate on a surface parallel to the YZ surface. The plurality of VCSELs 21 are disposed in an approximately circular region as illustrated in FIG. 2A, but may be arranged in a rectangular or linear shape, and an arrangement pattern is arbitrary. The number of VCSELs 21 included in the laser array 5 is arbitrary. For example, 512 VCSELs 21 are arranged in a chip of 1 mm×1 mm. Further, the VCSELs can be easily arrayed in high density as compared with edge-emitting laser elements, and can be tested on a wafer before element isolation in a semiconductor manufacturing process. Therefore, semiconductor lasers can be manufactured without cleaving, and can be provided at low cost. The vertical cavity surface emitting laser elements emit a laser beam in a direction orthogonal to a substrate surface on which the laser elements are mounted. The edge-emitting laser elements emit a laser beam in a direction parallel to a substrate surface on which the laser elements are mounted.

As illustrated in FIG. 2B, each VCSEL 21 includes a pair of resonance mirrors 22a and 22b, and a light emitting layer 23 disposed between the pair of resonance mirrors 22a and 22b. Out of the pair of resonance mirrors 22a and 22b, the resonance mirror 22a on an aperture (a light emission opening) side has a characteristic of reflecting light of a predetermined wavelength. Each part of the light emitting layer 23 is brought into an excited state by being supplied with driving power, and emits light at the time of returning to a base state. Out of the light generated by the light emitting layer 23, the light of the predetermined wavelength is reflected by each of the pair of resonance mirrors 22a and 22b, so that the light of the predetermined wavelength reciprocates repeatedly between the pair of resonance mirrors 22a and 22b. Accordingly, induced emission occurs in the light emitting layer 23, and a gain of the induced emission exceeds 1 so that laser oscillation occurs. Reflectance of the light of the predetermined wavelength from the resonance mirror 22a is set so that the reflectance becomes less than 100% within a range in which the gain exceeds 1. Part of the illumination laser beam L2 of the predetermined wavelength generated by the laser oscillation is emitted from the aperture to an outside by passing through the resonance mirror 22a.

A phase of a laser beam L2a emitted from each of the plurality of VCSELs 21 is uniform for each VCSEL 21, but is random to other VCSELs 21 and is generally displaced from phases of the other VCSELs 21. That is, a total illumination laser beam L2 emitted from the plurality of VCSELs 21 has dispersion according to the number of the VCSELs 21 provided in the laser array 5, and has low coherence as compared with a laser beam emitted from a single laser element. Further, a wavelength of the laser beam L2a emitted from each of the plurality of VCSELs 21 depends on an optical distance between the pair of resonance mirrors 22a and 22b, and a composition and the like of the light emitting layer 23. The optical distance, and the composition and the like of the light emitting layer 23 have variations due to manufacturing errors and the like, even when design values are the same among the plurality of VCSELs 21. Therefore, the total illumination laser beam L2 emitted from the plurality of VCSELs 21 has a larger wavelength width (e.g., a half-value width) and lower coherence as compared with those of the laser beam emitted from a single laser element.

Referring back to the description of FIG. 1, the illumination optical system 25 is provided inside the machining head 2. The illumination optical system 25 illuminates the workpiece W with the illumination laser beam L2 generated by the laser array 5 (irradiates the workpiece W with the illumination laser beam L2 through an emission port of the nozzle 11, by guiding the illumination laser beam L2 toward the workpiece W). The illumination optical system 25 includes the collimator 26, a half mirror 27, the beam splitter 18, and the condensing lens 19. In this case, the illumination optical system 25 shares the beam splitter 18 and the condensing lens 19 with the irradiation optical system 15, and carries out vertical illumination via the condensing lens 19. An optical axis on a light emission side of the illumination optical system 25 (the optical axis 19a of the condensing lens 19) is coaxial with an optical axis on a light emission side of the irradiation optical system 15 (the optical axis 19a of the condensing lens 19). The illumination laser beam L2 irradiates the workpiece W by passing through the same optical path as that of the machining laser beam L1. Further, the illumination optical system 25 has a focal point on an object side (hereinafter, referred to as the illumination-side focal point), and a focal point on an image side where the light emitted from the illumination-side focal point is condensed via the illumination optical system 25 (hereinafter, referred to as the workpiece-side focal point). These focal points are in an optically conjugate positional relationship. Therefore, by determining the workpiece-side focal point on the surface of the workpiece W and by disposing a light source at a position of a corresponding illumination-side focal point, the light can be condensed on the surface of the workpiece W via the illumination optical system 25, for example.

The collimator 26 is disposed at a position where the illumination laser beam L2 from the laser array 5 is incident. The collimator 26 converts the illumination laser beam L2 from the laser array 5 into parallel light, or brings the illumination laser beam L2 close to parallel light. When the workpiece-side focal point of the illumination optical system 25 is made to coincide with a target position of the workpiece, the collimator 26 is disposed so that the illumination-side focal point coincides with the position of the laser array 5 (the VCSELs 21 in FIG. 2A), for example.

The half mirror 27 is disposed at a position where the illumination laser beam L2 having passed through the collimator 26 is incident. The half mirror 27 is a reflection and transmission member that has a characteristic of reflecting part of the illumination laser beam L2 and transmitting part of the illumination laser beam L2 through the half mirror 27. The half mirror 27 is set so that, out of the illumination laser beam L2, a proportion of transmitted light becomes about 50% and reflected light becomes about 50%, for example. The half mirror 27 is inclined at an angle of about 45° to an optical axis 26a of the collimator 26. The half mirror 27 is inclined toward the −X side as the half mirror 27 is directed toward the +Z side.

Part of the illumination laser beam L2 having passed through the collimator 26 is reflected by the half mirror 27, and an optical path is bent by about 90° from the X direction to the Z direction (the −Z side), so that the part of the illumination laser beam L2 is incident to the beam splitter 18. As described above, the half mirror 27 is inclined in one direction to the optical axis of the condensing lens 19 (e.g., a direction toward the −X side as the half mirror 27 is directed toward the +Z side), and the beam splitter 18 (the wavelength selection mirror) is inclined to the optical axis of the condensing lens 19 in a direction opposite to a direction in which the half mirror 27 is inclined (e.g., a direction toward the +X side as the beam splitter 18 is directed toward the +Z side). Light transmitted through the beam splitter 18 and the half mirror 27 has an optical path shifted by refraction by the beam splitter 18, and has the optical path shifted by refraction by the half mirror 27. When the inclination to the optical axis 19a is mutually opposite between the beam splitter 18 and the half mirror 27, at least a part of a shift of an optical path in the beam splitter 18 can be offset by a shift of an optical path in the half mirror 27.

The condensing lens 19 is disposed at a position where the illumination laser beam L2 is incident from the beam splitter 18. The condensing lens 19 condenses the machining laser beam L1 from the beam splitter 18.

An irradiation region, which is irradiated with the illumination laser beam L2, on the workpiece W is set so as to include an irradiation region, which is irradiated with the machining laser beam L1, on the workpiece W. The laser array 5 and the illumination optical system 25 are configured such that a region illuminated by the laser array 5 (hereinafter, referred to as a projection region), which is determined based on a size of the laser array 5 and optical magnification of the illumination optical system 25, includes a whole region of the emission port of the nozzle 11 (a whole region of a cross section orthogonal to an emission direction of the illumination laser beam L2).

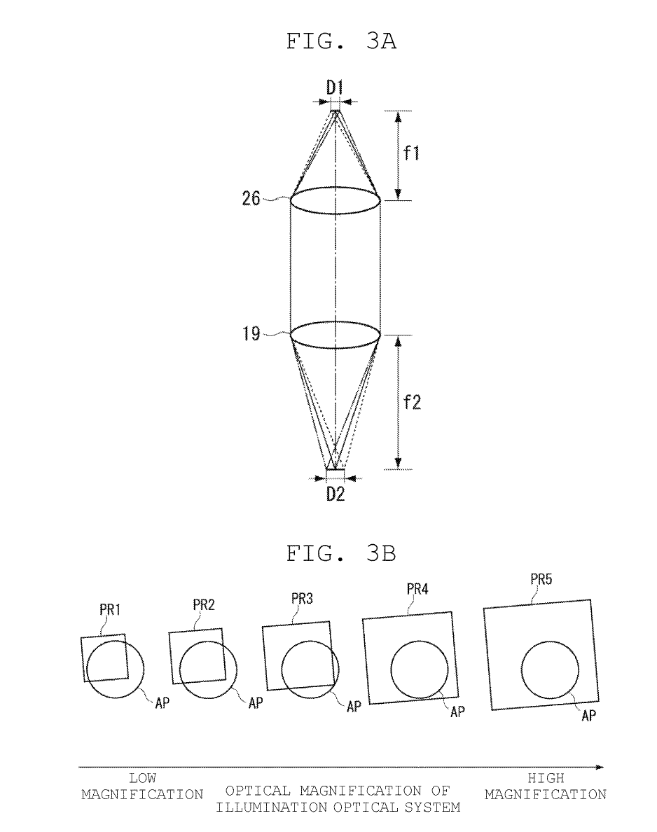

FIGS. 3A and 3B are explanatory diagrams concerning optical magnification of the illumination optical system. A size D2 of the projection region depends on a size D1 of the laser array 5 (a size of a region in which the VCSELs 21 are arranged), a focal distance f1 of the collimator 26, and a focal distance f2 of the condensing lens 19, and is determined by the following expression (1). In the expression (1), optical magnification is f2/f1.

D2=(f2/f1)×D1 (1)

Therefore, when D2 is larger than D1, even when a mechanical error (a positional displacement) occurs in positioning the laser array 5 or the optical axis of the beam splitter 18 is shifted by the setting of D1 and f1, a desired observation part of the workpiece W can be illuminated with the illumination laser beam L2. FIG. 3B illustrates a relationship between projection regions PR1 to PR5 and emission port regions AP of the nozzle 11 when the optical magnification of the illumination optical system 25 is changed. The optical magnification of the illumination optical system 25 is changed by selecting the collimator 26 of a different f1, for example. Out of the projection regions PR1 to PR5, the projection region PR1 has smallest optical magnification. The optical magnification becomes larger in the order of PR2, PR3, PR4, and PR5. On the other hand, when f1 is set too small in order to increase D2, illumination unevenness becomes too large, and this affects the observation of the workpiece W. When D1 is set too large in order to increase D2, increase in a driving current lowers energy efficiency. Therefore, it is desirable to select proper f1 and D1 according to f2. Instead of the emission port of the nozzle 11, the observation part itself of the workpiece may be set as a reference of an inclusion relationship of the projection region, for example. In this case, a size of the observation part of the workpiece may be determined by taking into account a rule of thumb so that the projection region can be covered.

The imaging unit 6 includes an imaging optical system 31 and an imaging element 32. The imaging unit 6 detects, by the imaging element 32 via the imaging optical system 31, light radiated from the workpiece W by illumination with the illumination laser beam L2. The imaging optical system 31 includes the condensing lens 19, the beam splitter 18, the half mirror 27, a wavelength selection filter 33, and an imaging lens 34. The imaging optical system 31 shares the condensing lens 19, the beam splitter 18, and the half mirror 27 with the illumination optical system 25. Therefore, when the image captured by the imaging unit 6 is used, the workpiece can be observed coaxially with the illumination optical system 25.

The light from the workpiece W (hereinafter, referred to as return light) is incident to the beam splitter 18 by passing through the condensing lens 19. The return light includes, for example, the light reflected and scattered by the workpiece W out of the illumination laser beam L2, and the light reflected by the workpiece W out of the machining laser beam L1. Out of the return light incident to the beam splitter 18, the light originating from the illumination laser beam L2 is incident to the half mirror 27 by passing through the beam splitter 18. Further, out of the return light incident to the beam splitter 18, the light originating from the machining laser beam L1 is reflected by the beam splitter 18, and is removed from the optical path directed from the beam splitter 18 to the half mirror 27.

When a molten metal of the workpiece W melted by irradiation with the machining laser beam L1 exists on the surface and the like of the workpiece W, the return light includes a wavelength band of red to near infrared which is radiated from the molten metal. Further, when plasma occurs following melting and evaporation of the workpiece W by irradiation with the machining laser beam L1, the return light includes a wavelength band of blue to ultraviolet. Out of the light originating from the molten metal or the plasma, the light having a wavelength different from that of the machining laser beam L1 is incident to the half mirror 27 by passing through the beam splitter 18.

Part of the return light incident to the half mirror 27 is incident to the wavelength selection filter 33 by passing through the half mirror 27. Part of the return light incident to the wavelength selection filter 33 is reflected by the half mirror 27. The wavelength selection filter 33 has a characteristic of reflecting the light of a first wavelength band which is reflected by the workpiece W by illumination with the illumination laser beam L2. Further, the wavelength selection filter 33 has a characteristic of transmitting the light of a second wavelength band which is radiated from the workpiece W by irradiation with the machining laser beam L1. The wavelength selection filter 33 is a dichroic mirror or a notch filter, for example. By detecting the transmitted light of the second wavelength band by separate detecting means such as a light amount sensor, for example, a machining state may be measured at a point different from that of the kerf width.

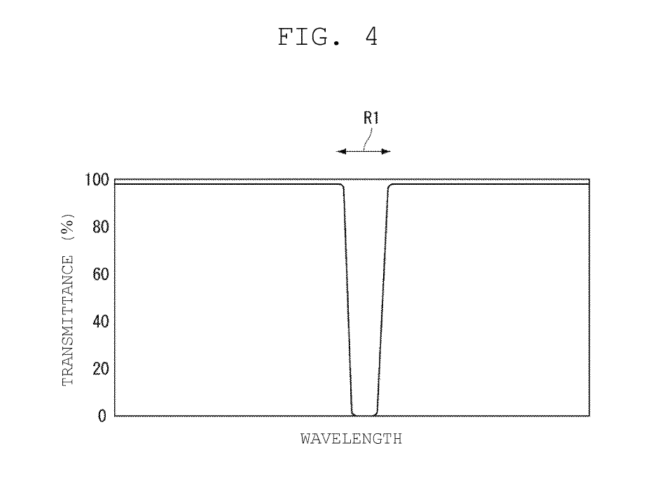

FIG. 4 is a diagram illustrating a characteristic of the wavelength selection filter 33. In FIG. 4, a lateral axis indicates a wavelength, and a vertical axis indicates transmittance of each wavelength of the wavelength selection filter 33. A reflection wavelength band R1 (the first wavelength band) of the wavelength selection filter 33 is set in a narrow band that includes a wavelength which becomes largest in a distribution of light intensity of the wavelength of the illumination laser beam L2, for example.

Referring back to the description of FIG. 1, out of the return light, the light originating from the illumination laser beam L2 is reflected by the wavelength selection filter 33, and is incident to the imaging lens 34. Accordingly, because the disturbance light included in the return light can be blocked, an S/N ratio of the image is improved. The imaging lens 34 condenses the light reflected by the wavelength selection filter 33 in the imaging element 32. The imaging lens 34 and the condensing lens 19 project the image of the workpiece W on the imaging element 32.

For the imaging element 32, an image sensor of a CCD or a CMOS is used, for example, and the imaging element 32 captures an image formed by the imaging optical system 31. A plurality of pixels arranged two dimensionally are provided in the imaging element 32. In each pixel, a light receiving element such as a photodiode is provided. The imaging element 32 sequentially reads charges (signals) that occur in pixels by incidence of light into the light receiving element. By amplifying and A/D converting and arranging the signals in the image format, the imaging element 32 generates digital data of a captured image (hereinafter, referred to as captured image data). The imaging element 32 outputs the generated captured image data to the image processor 8.

In this case, the imaging element 32 is held in an alignment device 35. The alignment device 35 can adjust a position of the imaging element 32 with respect to the imaging optical system 31. For example, when a focal point (a position of an image surface) of the imaging optical system 31 is displaced in a direction (the X direction) parallel to an optical axis 34a of the imaging lens 34, the alignment device 35 can make the position of the imaging element 32 coincide with the focal point of the imaging optical system 31 by moving the imaging element 32.

The image processor 8 is communicably connected to the imaging element 32 by wire or wireless. The image processor 8 processes an imaging result (the captured image data) of the imaging element 32. In this case, the image processor 8 also serves as a controller of the imaging element 32. The image processor 8 is communicably connected to the controller 9 by wire or wireless, and receives a command for executing imaging from the controller 9. The image processor 8 makes the imaging element 32 execute the imaging in accordance with the command from the controller 9. Further, the image processor 8 obtains the captured image data from the imaging element 32, and generates information concerning the machining state by image processing using the captured image data. For example, the image processor 8 measures the kerf width in the cutting using the machining laser beam L1, and supplies the measurement result to the controller 9 as the information concerning the machining state. In detecting the kerf width, for example, the image processor 8 processes the image captured by the imaging element 32, and detects positions of edges corresponding to edges of the cutting groove by the laser beam machining. Thereafter, the image processor 8 converts a distance between the edges on the image (e.g., in units of pixels) into a distance in an actual scale (e.g., in units of mm).

In the present embodiment, there is used the laser array 5 that has the plurality of VCSELs 21 (refer to FIG. 2A) arranged as the light source of the illumination laser beam L2. Therefore, coherence of the illumination laser beam L2 is low, and inclusion of interference fringes and speckle patterns in the image captured by the imaging element 32 is reduced. Therefore, the image processor 8 can detect the information concerning the machining state (e.g., a kerf width) with high accuracy, by the image processing using the captured image.

The VCSELs 21 have high illuminance per unit area and narrow emission light (have high parallelism). Therefore, as illustrated in FIG. 2A, by arranging a plurality of VCSELs 21, on the end surface from which the laser array 5 emits the illumination laser beam L2, a light intensity distribution becomes a non-uniform distribution having a maximum at each position of each VCSEL 21. Therefore, when the workpiece-side focal point of the illumination optical system 25 coincides with the position of the surface of the workpiece W, the laser array 5 as the light source is projected as is, so that the illuminance of the surface of the workpiece W becomes non-uniform. Accordingly, in the present embodiment, the laser array 5 is disposed at a position displaced from the illumination-side focal point which is optically conjugate with the workpiece-side focal point of the illumination optical system 25. That is, the laser array 5 is disposed at a position where a focal point of the illumination laser beam L2 is at a position different from a position of the surface of the workpiece W, the illumination laser beam L2 being emitted by the laser array 5 and having passed through the illumination optical system 25. Accordingly, the light intensity distribution of the illumination laser beam L2 in the laser array 5 can be set uniform, so that the image captured by the imaging element 32 can be easily observed.

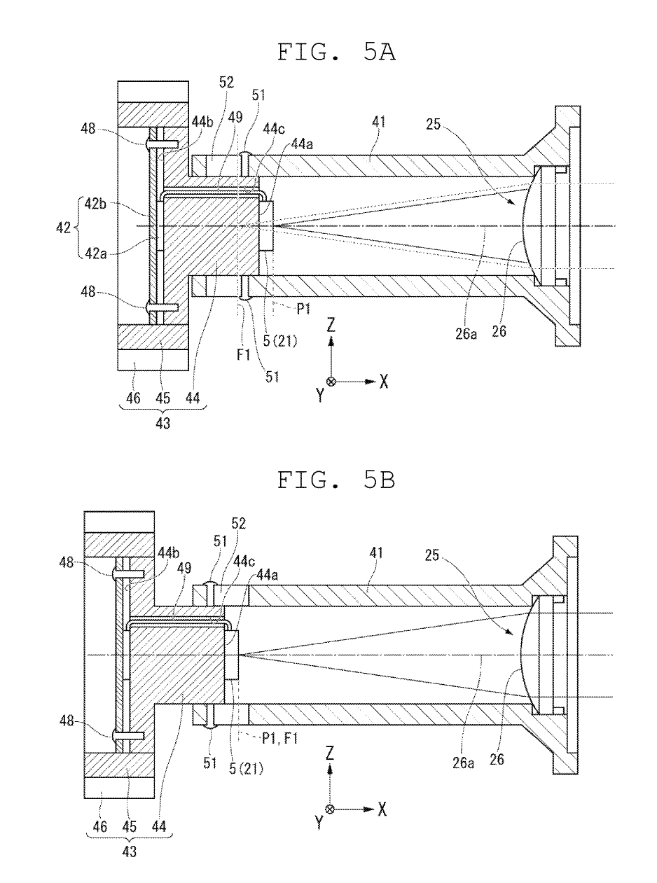

FIGS. 5A and 5B are diagrams illustrating a part of the laser array 5 and the illumination optical system 25 (set as the illuminating unit 28) according to the present embodiment. FIG. 5A illustrates a state where the laser array 5 is disposed at a position displaced from the illumination-side focal point F1 of the illumination optical system 25. FIG. 5B illustrates a state where the laser array 5 is disposed at a position of the illumination-side focal point F1 of the illumination optical system 25. The collimator 26 is fixed to a cylindrical case 41 (a barrel), and the laser array 5 is slidably provided to the case 41. This will be described in detail below.

In the present embodiment, the laser array 5 and a driving unit 42 (a driver) are fitted to a heat dissipation member 43. The heat dissipation member 43 is in contact with the driving unit 42 and the laser array 5. The heat dissipation member 43 is made of a material having high thermal conductivity and a small heat capacity such as aluminum and copper, for example. The heat dissipation member 43 includes a body part 44, a housing part 45, and a fin 46. The body part 44, the housing part 45, and the fin 46 may be integrally formed by molding or the like, or may be integrally joined together by welding to inhibit disassembling, or may be integrally joined together by bolts to allow disassembling.

The body part 44 has a shape of a rotor, and has a surface 44a, and a surface 44b facing an opposite direction. The laser array 5 is mounted on the surface 44a, and is in contact with the body part 44.

The driving unit 42 is configured by a laser driver IC 42a, a printed substrate 42b, and an electronic component (not illustrated). The laser driver IC 42a is an IC for pulse driving the laser array 5 with a constant current, for example. The laser driver IC 42a is mounted on the printed substrate 42b, and is in contact with the body part 44 (the surface 44b). The driving unit 42 (the printed substrate 42b) is fixed to the body part 44 with a fixing member 48. As described above, the driving unit 42 and the laser array 5 are disposed so as to sandwich the body part 44 of the heat dissipation member 43, for example. In order to avoid generation of a gap at least at a part between the laser array 5 and the surface 44a and between the driving unit 42 and the surface 44b, a heat-conductive paste may be coated or a heat dissipation sheet may be sandwiched. Further, because the heat dissipation member 43 serves as both the mount of the laser array 5 and the case of the driving unit 42, there is an effect of making the illuminating unit 28 compact and light weight.

The body part 44 is provided with a through-hole 44c that communicates with the surface 44a and the surface 44b. The driving unit 42 and the laser array 5 are electrically connected to each other by a wire 49 that passes through an inside (the through-hole 44c) of the body part 44 of the heat dissipation member 43. The driving unit 42 is controlled by the image processor 8 (refer to FIG. 1), and drives the VCSELs 21 of the laser array 5 by supplying power (a current) to the laser array 5 through the wire 49. Because the workpiece W moves relative to the machining head 2 at a high speed, in order to obtain the machining state with high accuracy, imaging by short-time exposure is desirable. Therefore, it is required to pulse drive the laser array 5 with a large current. With the above configuration, the wire 49 can be set in a shortest path. Therefore, a resistance component and an inductive load component become small, and rising characteristics of the driving current of the laser array 5 by the laser driver IC 42a become quick. As a result, satisfactory performance to the large-current pulse drive can be obtained. The housing part 45 is a frame-shaped (annular) portion that surrounds the end part of a surface 44b side of the body part 44. The driving unit 42 is disposed inside the housing part 45. The housing part 45 also serves as a housing case of the driving unit 42. A plurality of the fins 46 are radially provided from an outer peripheral surface of the housing part 45. By increasing a surface area of the heat dissipation member 43, heat dissipation is enhanced. The heat dissipation member 43 is naturally cooled by air, but maybe forcibly cooled by air by providing a fan motor, for example. Alternatively, the heat dissipation member 43 may dissipate heat through a heat medium such as water cooling.

The body part 44 is inserted inside the case 41 in a posture of directing the surface 44a to the collimator 26. The body part 44 is fitted to the case 41 with a fitting member 51. The case 41 is provided with a slit 52 that extends in a direction (the X direction) parallel to the optical axis 26a of the collimator 26. The fitting member 51 is fixed to the body part 44 through the inside of the slit 52. Further, an end part (a head part) of the fitting member 51 is larger than a width of the slit 52, and suppresses loosening of the body part 44 to the case 41 in directions (the Y direction, the Z direction) intersecting the optical axis 26a of the collimator 26. Because force in the X direction is applied to the heat dissipation member 43, the fitting member 51 moves inside the slit 52. A movable range of the heat dissipation member 43 is defined by a size of the slit 52.

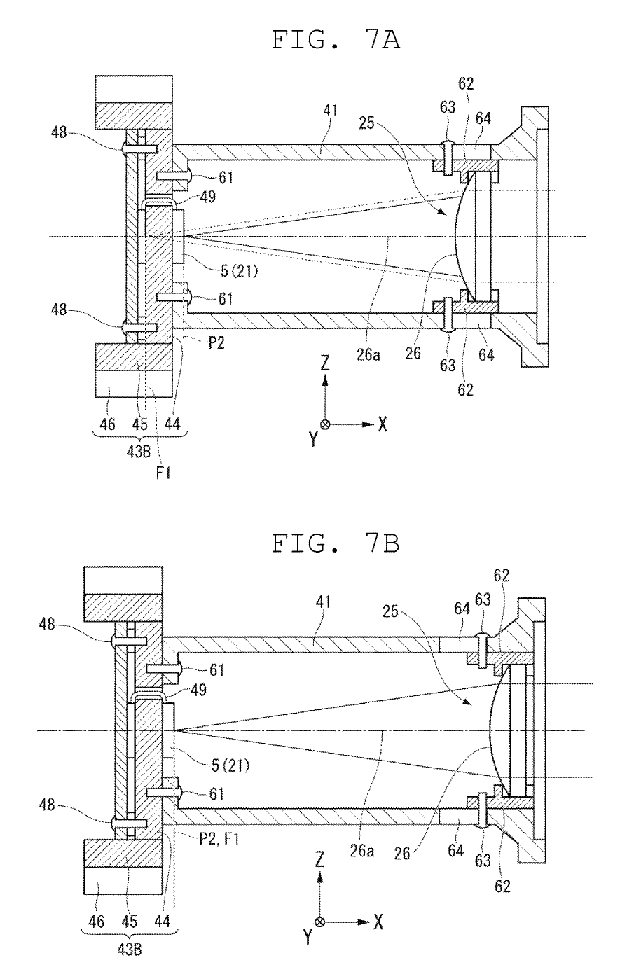

For example, in FIG. 5A, the fitting member 51 is in contact with an end on the +X side of the slit 52. In this state, a distance (a defocusing amount) between a position P1 from which the laser array 5 emits the illumination laser beam L2 and an illumination-side focal point F1 of the collimator 26 becomes largest. Further, in FIG. 5B, the laser array 5 moves to the −X side as compared with a position of the laser array 5 in FIG. 5A, and the fitting member 51 is in contact with an end on the −X side of the slit 52. In this state, the position P1 from which the laser array 5 emits the illumination laser beam L2 and the illumination-side focal point F1 of the collimator 26 are substantially at the same position, and the defocusing amount becomes smallest. In this way, the laser array 5 (the VCSELs 21) is fitted so that a relative positional relationship between the workpiece-side focal point of the illumination optical system 25 and the optically conjugate focal point (the illumination-side focal point F1) is variable. In this case, by making the laser array 5 (the VCSELs 21) movable with respect to the collimator 26 (the illumination optical system 25) via the slit 52 (the position change part), a relative positional relationship between the laser array 5 and the illumination-side focal point F1 (the illumination optical system 25) is made variable. Further, the collimator 26 may be movable with respect to the laser array 5 (the VCSELs 21) (described later with reference to FIGS. 7A and 7B).

Referring back to the description of FIG. 1, the image processor 8 also serves as a controller of the laser array 5. The image processor 8 is communicably connected to the driving unit 42 (illustrated in FIGS. 5A and 5B) of the laser array 5 by wire or wireless. For the laser array 5 to emit the illumination laser beam L2 synchronously with the timing at which the imaging element 32 performs the imaging, the image processor 8 supplies, to the driving unit 42 of the laser array 5, a control signal to make the laser array 5 execute the emission (the laser array 5 is driven by pulse drive described later). The driving unit 42 makes the laser array 5 radiate the laser beam by driving the laser array 5 with a constant current only during a valid period of the control signal. For example, the control signal is in a pulse shape. The image processor 8 causes the imaging element 32 to perform the imaging so that at least a part of a period from rising to falling of each pulse (a period of one pulse width) concerning the laser array 5 is overlapped with a period of the imaging element 32 accumulating charges (a charge accumulation period). The period of one pulse width is desirably equal to or less than the charge accumulation period, but may have the same length as the charge accumulation period, or may be longer than the charge accumulation period. The image processor 8 may not control at least one of the imaging element 32 and the laser array 5. For example, the controller 9 may control at least one of the imaging element 32 and the laser array 5, in place of the image processor 8. The control signal for driving the laser array 5 may be supplied from the imaging element 32 to the driving unit 42.

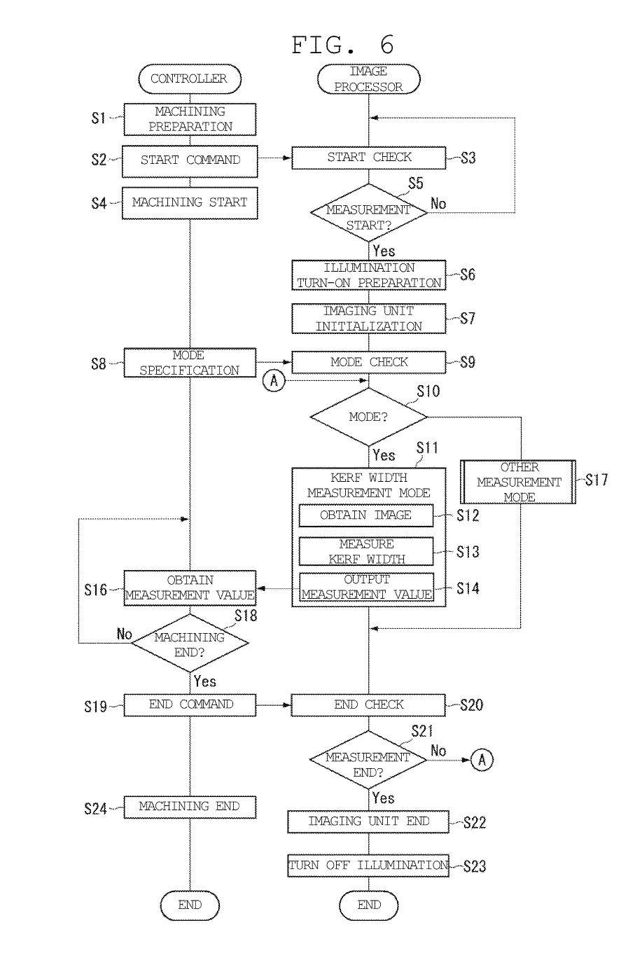

Next, a laser beam machining method according to the embodiment will be described based on the configuration of the laser beam machine 1. FIG. 6 is a sequence diagram illustrating operations of the controller 9 and the image processor 8. In step S1, the controller 9 carries out machining preparation (pre-processing). For example, the controller 9 has the workpiece W loaded, and prepares an assist gas. In step S2, the controller 9 sends a measurement start command to the image processor 8. In step S3, the image processor 8 has the start command reflected in a start check. The start check is a flag indicating whether or not the start command has been received, for example. For example, the flag of the start check is “0” when the start command has not been received. When the start command in step S2 is received, the flag changes to “1” which indicates a state where the start command has been received.

In step S4, the controller 9 has the machining started. For example, the controller 9 has injection of the assist gas started, and makes the laser oscillator 4 output the machining laser beam L1 so as to make the irradiation optical system 15 irradiate the workpiece W with the machining laser beam L1. Further, the controller 9 makes the head driving unit 3 move the machining head 2 so as to control the position of the workpiece W irradiated with the machining laser beam L1.

In step S5, the image processor 8 determines whether or not to start the measurement. For example, when the flag of the start check in step S3 indicates a state where the start command is not received, the image processor 8 determines not to start the measurement (No in step S5), and returns to the processing of step S3. When the flag of the start check in step S3 indicates a state where the start command is received, the image processor 8 determines to start the measurement (Yes in step S5). That is, the image processor 8 repeats the processing of step S5, and waits until the start command of the measurement is received from the controller 9.

When the image processor 8 determines to start the measurement (Yes instep S5), the image processor 8 makes the laser array 5 prepare for a light emission state, in step S6. In step S7, the image processor 8 initializes the imaging unit 6. For example, in step S7, the image processor 8 sets the imaging condition including a shutter speed of the imaging unit 6, and makes the imaging unit 6 prepare for the imaging state.

In step S8, the controller 9 supplies a mode specification to the image processor 8. The mode command is a command for specifying a mode for measuring a machining state. In this case, it is assumed that there are two kinds of measurement modes. A description will be made by assuming that one measurement mode is a mode for measuring a kerf width (hereinafter, referred to as a kerf width measurement mode), and the other measurement mode is a mode for measuring other items (hereinafter, referred to as the other measurement mode). There may be one kind of measurement mode or three or more kinds of measurement modes.

In step S9, the image processor 8 checks a measurement mode that is specified by the mode command. In step S10, the image processor 8 determines which one of the measurement modes to execute. For example, the image processor 8 determines whether or not the measurement mode indicated by the mode check is the kerf measurement mode. When the measurement mode specified by the controller 9 is the kerf measurement mode, the image processor 8 determines to execute the kerf measurement mode (Yes in step S10). When the measurement mode indicated by the mode check is not the kerf measurement mode, the image processor 8 determines to execute the other measurement mode (No in step S10).

When the image processor 8 determines to execute the kerf measurement mode (Yes in step S10), the image processor 8 executes the kerf measurement mode in step S11. In step S12 of step S11, the image processor 8 has the image of the workpiece W obtained. For example, the image processor 8 sends a command to the imaging element 32 to execute the imaging, and obtains captured image data from the imaging element 32. In step S12, the image processor 8 supplies a control signal to the driving unit 42 for making the laser array 5 execute the light emission. The driving unit 42 makes the laser array 5 generate the laser beam by driving the laser array 5 with a constant current only during a valid period of the control signal. In step S13, the image processor 8 measures the kerf width. The image processor 8 measures the kerf width by the image processing using the captured image data obtained from the imaging element 32. In step S14, the image processor 8 outputs a measurement value of the kerf width measured in step S13. For example, the image processor 8 sends a measurement value of the kerf width to the controller 9. In step S16, the controller 9 obtains the measurement value of the kerf width from the image processor 8. The controller 9 makes the storage unit 10 store the information of the machining state obtained from the image processor 8 (e.g., the measurement value of the kerf width), in association with machining position information of the workpiece W during the machining (e.g., XYZ coordinate values of the machining head 2).

The image processor 8 may not output the measurement result, and may make a storage unit (not illustrated) inside the image processor 8 or the storage unit 10 stores the measurement result, for example. When the other measurement mode is specified in step S10, the image processor 8 executes the other measurement mode in step S17.

Instep S18, the controller 9 determines whether or not to end the machining. For example, when all processes determined by the numerical control program ends, the controller 9 determines to end the machining (Yes in step S18). When a part of the processes determined by the numerical control program has not ended, the controller 9 determines not to end the machining (No in step S18). When the controller 9 determines not to end the machining (No in step S18), the controller 9 has the remaining processes executed, and returns to step S16 again. When the controller 9 determines to end the machining (Yes in step S18), the controller 9 sends the end command to the image processor 8 in step S19. In step S20, the image processor 8 has the end command reflected in an end check. The end check is a flag indicating whether or not the end command has been received, for example. For example, the flag of the end check is “1” when the end command has not been received. When the end command in step S19 is received, the flag changes to “0” which indicates a state where the end command has been received.

In step S21, the image processor 8 determines whether or not to end the measurement. When the flag of the end check in step S20 indicates a state where the end command is not received, the image processor 8 determines not to end the measurement (No in step S21), and returns to step S10 (denoted by “A” in the figure) and repeats the processing of step S10 and subsequent steps. When the flag of the end check in step S20 indicates a state where the end command is received, the image processor 8 determines to end the measurement (Yes in step S21) and causes the imaging unit 6 to end the imaging operation in step S22. Further, in step S23, the image processor 8 turns off the illumination. For example, the image processor 8 sends a command to the driving unit 42 to stop driving of the laser array 5. In step S24, the controller 9 ends the machining.

### Second Embodiment

A second embodiment will be described. In the present embodiment, configurations similar to those of the above embodiment will be denoted with the same reference numbers, and description thereof will be omitted or simplified. FIGS. 7A and 7B are diagrams illustrating the laser array 5, a part of the illumination optical system 25, and a heat dissipation member 43B according to the present embodiment. In the present embodiment, the heat dissipation member 43B is fixed to the case 41 with a fixing member 61. That is, the laser array 5 is fixed to the case 41 via the heat dissipation member 43B. The collimator 26 (the illumination optical system 25) is movable with respect to the laser array 5 via a slit 64 described later (a position change part).

The collimator 26 is held by a holding member 62. The holding member 62 is inserted inside the case 41. The holding member 62 is slidable with respect to the case 41 in a direction (the X direction) parallel to the optical axis 26a of the collimator 26. The holding member 62 is fitted to the case 41 with a fitting member 63. The case 41 is provided with a slit 64 that extends in a direction (the X direction) parallel to the optical axis 26a of the collimator 26. The fitting member 63 is fixed to the holding member 62 through the inside of the slit 64. Further, an end part (a head part) of the fitting member 63 is larger than a width of the slit 64, and suppresses loosening of the holding member 62 with respect to the case 41 in directions (the Y direction, the Z direction) intersecting the optical axis 26a of the collimator 26. When the fitting member 63 moves in the X direction inside the slit 64, the collimator 26 held by the holding member 62 moves in the X direction with respect to the case 41. A movable range of the collimator 26 is defined by a size of the slit 64.

For example, in FIG. 7A, the fitting member 63 is in contact with an end on the -X side of the slit 64. In this state, a distance (a defocusing amount) between a position P2 from which the laser array 5 emits the illumination laser beam L2 and the illumination-side focal point F1 of the collimator 26 becomes largest. Further, in FIG. 7B, the laser array 5 moves to the +X side as compared with a position of the laser array 5 in FIG. 7A, and the fitting member 63 is in contact with an end on the +X side of the slit 64. In this state, the position P2 from which the laser array 5 emits the illumination laser beam L2 and the illumination-side focal point F1 of the collimator 26 are substantially at the same position, and the defocusing amount becomes smallest. In this way, the laser array 5 (the VCSELs 21) is fitted so that a relative positional relationship between the workpiece-side focal point of the illumination optical system 25 and the optically conjugate focal point (the illumination-side focal point F1) is variable, for example.

### Third Embodiment

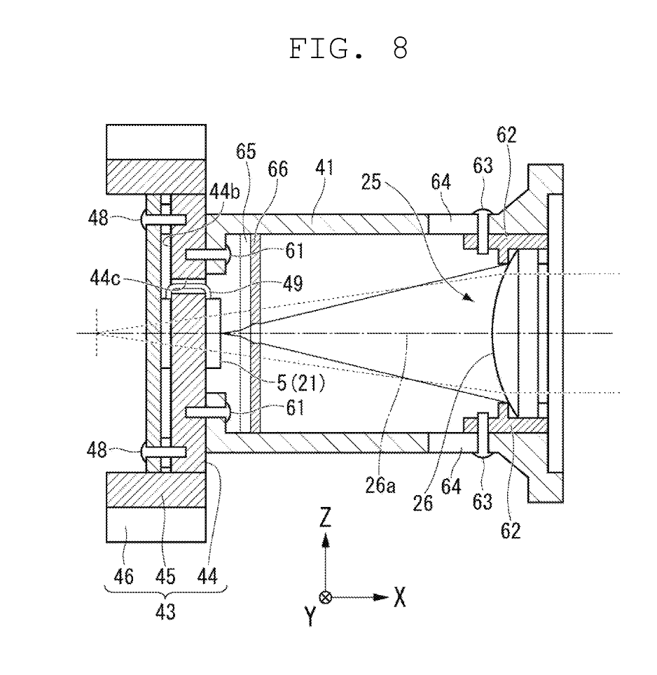

A third embodiment will be described. In the present embodiment, configurations similar to those of the above embodiment will be denoted with the same reference numbers, and description thereof will be omitted or simplified. FIG. 8 is a diagram illustrating the laser array 5, a part of the illumination optical system 25, the heat dissipation member 43, a diffusion member 65, and a diaphragm member 66 according to the present embodiment. The laser array 5, the part of the illumination optical system 25, and the heat dissipation member 43 may be similar to those in FIG. 4 or FIGS. 7A and 7B.

In the present embodiment, the diffusion member 65 is disposed in the optical path between the laser array 5 and the workpiece W (refer to FIG. 1). The diffusion member 65 is disposed in the optical path between the laser array 5 and the illumination optical system 25 (the collimator 26). The diffusion member 65 may be disposed such that a distance from the diffusion member 65 to the laser array 5 is shorter than a distance from the diffusion member 65 to the collimator 17, for example. In FIG. 8, while the diffusion member 65 is fixed to the case 41, the diffusion member 65 may be configured such that a relative positional relationship with the laser array 5 is adjustable. The illumination laser beam L2 from the laser array 5 is diffused.

The diffusion member 65 may be frosted glass or a diffraction grating, for example.

As described with reference to FIG. 2A, because the plurality of VCSELs 21 are arranged in the laser array 5, on the end surface from which the laser array 5 emits the illumination laser beam L2, the light intensity distribution becomes a non-uniform distribution having a high illuminance portion at each position of each VCSEL 21. In the present embodiment, the illumination laser beam L2 from the plurality of VCSELs 21 is diffused by the diffusion member 65, and the illuminance on the workpiece W is made uniform. The laser array 5 (the VCSELs 21) may be movable relative to the collimator 26 in a similar manner to that in the first embodiment or the second embodiment, or a relative position with the collimator 26 may be fixed.

Further, in the present embodiment, a diaphragm member 66 is disposed in the optical path between the diffusion member 65 and the illumination optical system (the collimator 26). A size of an opening of the diaphragm member 66 is set so as to block the light directed to the outside of the collimator 26, out of the illumination laser beam L2 diffused by the diffusion member 65. The diaphragm member 66 is integrated with the diffusion member 65 and is fixed to the case 41, for example.

### Fourth Embodiment

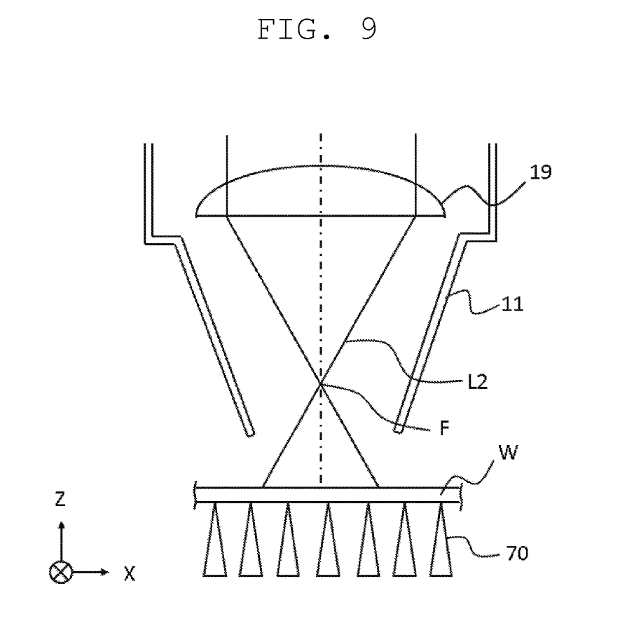

A fourth embodiment will be described. In the present embodiment, configurations similar to those of the above embodiment will be denoted with the same reference numbers, and description thereof will be omitted or simplified. FIG. 9 is a diagram illustrating a focal point of an illumination laser beam. In the present embodiment, defocus of a focal point (a workpiece-side focal point) of the illumination laser beam L2 having passed through the illumination optical system 25 will be described in more detail.

In the present embodiment, the laser beam machine 1 includes a supporting member 70 that supports the workpiece W with a prescribed supporting surface. As illustrated in FIG. 9, the supporting member 70 is a pin holder that is configured by a plurality of needle-shaped bars, and forms a prescribed supporting surface by having the front ends of these needle-shaped bars integrated together.

In this case, the laser beam machine 1 carries out laser beam machining on an arbitrary workpiece W based on various kinds of machining condition (including parameters of materials and the like of the workpiece W, for example), and an interval between the workpiece surface and a front end of the machining head (hereinafter referred to as a nozzle gap) and the like are set in accordance with the machining condition. Therefore, even when the focal point of the illumination laser beam F2 is displaced from the workpiece surface to the machining head side, when the nozzle gap is changed according to the change in the machining condition, the focal point may be positioned on the workpiece surface. Note that the laser beam machine 1 has a detecting unit for measuring the nozzle gap, and is capable of driving the machining head to obtain a desired nozzle gap based on a detection value of the detection unit.

In the present embodiment, the laser array 5 is disposed at a position (a position on the nozzle side with respect to the workpiece surface)where the focal point of the illumination laser beam F2 is located inside the machining head 2 (including the inside of the nozzle 11). More specifically, inside the machining head 2, the focal point of the illumination laser beam F2 is positioned between the front end of the nozzle 11 and the condensing lens 19. Accordingly, regardless of the change in the nozzle gap, the light intensity distribution of the illumination laser beam L2 of the laser array 5 can be reliably averaged to the workpiece. The laser beam machine 1 causes the optical system driving unit 13 to move the condensing lens 19 along the optical axis 19a in accordance with the machining condition. It is desirable to dispose the laser array 5 so that the focal point of the illumination laser beam F2 is positioned between the front end of the nozzle 11 and a close contact position where the condensing lens 19 is closest to the workpiece W side within a moving range of the condensing lens 19. Accordingly, after the illumination laser beam F2 is properly passed through the condensing lens 19, the illumination laser beam F2 can be condensed at a position different from the position of the workpiece surface.

The laser beam machine 1 can be also configured in a mode other than the present embodiment. For example, in the laser beam machine 1, the laser array 5 may be disposed in a state where the focal point of the illumination laser beam F2 is positioned on the machining head side (the nozzle side) and at a position where the focal point is not located inside the machining head 2. In particular, the laser array 5 may be disposed in a state where the focal point of the illumination laser beam F2 is positioned within a smallest nozzle gap (between the surface of the workpiece W closest to the nozzle 11 and the front end of the nozzle 11) of all the nozzle gaps set in accordance with the machining condition and the like. In this case as well, it is possible to reliably defocus the focal point of the illumination laser beam F2 on the workpiece W regardless of the change in the nozzle gap. Alternatively, the laser array 5 may be disposed in a state where the focal point of the illumination laser beam F2 is positioned on the supporting member 70 side (a side opposite to the machining head 2) with respect to the workpiece surface. In this case as well, because the focal point of the illumination laser beam F2 is positioned on the supporting member 70 side beyond the workpiece W, it is possible to reliably defocus the workpiece. However, because there is a constant distance from the machining head 2 to the supporting member 70, as compared with the case where the laser array 5 is disposed on the machining head side, the disposition may receive a physical constraint.

In the above embodiment, the controller 9 includes a computer system, for example. The controller 9 reads a control program stored in a storage unit 10, and executes various kinds of processing following the control program. The control program causes a computer to execute, for example, a control of generating a machining laser beam and irradiating the workpiece with the machining laser beam, a control of generating illumination light from a laser array in which a plurality of vertical cavity surface emitting laser elements are arranged and irradiating the workpiece with the illumination light, and a control of imaging the workpiece illuminated with the illumination light. This control program may be provided by being recorded in a computer-readable storage medium.

In the above embodiment, the illumination optical system 25 carries out vertical illumination with the illumination laser beam L2 coaxially with the imaging optical system 31. However, the illumination optical system 25 may obliquely illuminate the optical axis of the imaging optical system 31 (the optical axis 19a of the condensing lens 19) with the illumination laser beam L2, for example. Further, the wavelength selection filter 33 may have a characteristic of transmitting the light of the wavelength band (the first wavelength band) of the illumination laser beam L2, and reflecting the light of the other wavelength band (the second wavelength band). In this case, the imaging element 32 is disposed on the transmission side of the wavelength selection filter 33.

In the above embodiment, the laser beam machine 1 carries out cutting. However, the laser beam machine 1 can be also applied to a machine that carries out welding as laser beam machining, a machine that carries out marking, and a machine that carries out cutting and marking. The laser beam machine 1 may be a part of a composite machine that carries out laser beam machining and punching.

In the above embodiments, the laser array 5 has a configuration in which the plurality of vertical cavity surface emitting laser elements are disposed in an array, and includes various advantages in that high integration can be realized. However, the laser array 5 may have a configuration in which edge-emitting laser elements are disposed in an array, for example. As a specific example, when an array having edge-emitting laser elements arranged one dimensionally is arranged in a plurality of layers, the edge-emitting laser elements can be arranged two dimensionally. Further, the laser array 5 may be configured by disposing, in an array, surface-emitting laser elements other than the vertical cavity surface emitting laser elements. Further, there is no limit to an angle of disposing resonators on the substrate on which the laser elements are mounted.

A technical range of the present invention is not limited to modes described in the above embodiments. One or more requirements described in the above embodiments may be omitted. The requirements described in the above embodiments can be appropriately combined. To the extent permitted by laws and regulations, disclosures of all documents cited in the embodiments are used as a part of the description of the text.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A laser beam machine comprising:
a laser oscillator that emits a machining laser beam;
an irradiation optical system that irradiates a workpiece with the machining laser beam;
a laser array that has a plurality of laser elements disposed in an array and emits an illumination laser beam by output of the plurality of laser elements;
an illumination optical system that illuminates the workpiece with the illumination laser beam emitted by the laser array; and
an imaging unit that images the workpiece which is illuminated by the illumination optical system with the illumination laser beam.

2. The laser beam machine according to claim 1, wherein
in the laser array, the plurality of laser elements are arranged two dimensionally.

3. The laser beam machine according to claim 1, wherein
in the laser array, each of the plurality of laser elements is a vertical cavity surface emitting laser element.

4. The laser beam machine according to claim 1, wherein
the laser array is disposed at a position where a focal point of the illumination laser beam is at a position different from a position of a workpiece surface, the illumination laser beam being emitted by the laser array and having passed through the illumination optical system.

5. The laser beam machine according to claim 4, further comprising a nozzle provided with an emission port for emitting the illumination laser beam toward the workpiece via the illumination optical system,
wherein the laser array is disposed in a state where the focal point is positioned on a nozzle side with respect to the workpiece surface.

6. The laser beam machine according to claim 5, further comprising a machining head including the nozzle,
wherein the laser array is disposed at a position where the focal point is located inside the machining head.

7. The laser beam machine according to claim 1, comprising
a position change part adapted to change a relative positional relationship between the laser array and the illumination optical system, in an optical axis direction of the illumination optical system.

8. The laser beam machine according to claim 7, wherein
the illumination optical system comprises:
a collimator to which the illumination laser beam is incident from the laser array; and
a condensing lens to which the illumination laser beam is incident from the collimator,
wherein the position change part is adapted to change a relative positional relationship between the laser array and the collimator.

9. The laser beam machine according to claim 1, comprising
a diffusion member that is disposed in an optical path between the laser array and the workpiece.

10. The laser beam machine according to claim 9, wherein
the diffusion member is disposed in an optical path between the laser array and the illumination optical system.

11. The laser beam machine according to claim 9, comprising
a diaphragm member disposed in an optical path between the diffusion member and the illumination optical system.

12. The laser beam machine according to claim 1, comprising:
a driving unit that drives the laser array; and
a heat dissipation member that is in contact with the laser array.

13. The laser beam machine according to claim 12, wherein
the driving unit and the laser array are disposed so as to sandwich the heat dissipation member, and are electrically connected to each other by a wire that passes through a hole penetrating through the heat dissipation member.

14. The laser beam machine according to claim 1, wherein
the laser array is pulse driven, and
the imaging unit executes imaging synchronously with pulse drive of the laser array.

15. The laser beam machine according to claim 1, comprising:
a machining head that stores therein the irradiation optical system; and
an illuminating unit that stores therein the laser array and the illumination optical system,
wherein the illuminating unit is detachably connected to the machining head.

16. The laser beam machine according to claim 1, comprising
a nozzle provided with an emission port for emitting the illumination laser beam via the illumination optical system and emitting the machining laser beam via the irradiation optical system,
wherein the laser array and the illumination optical system are configured such that a projection region of the laser array defined by a size of the laser array and optical magnification of the illumination optical system includes an emission port region of the nozzle.

17. A laser beam machining method comprising:
emitting a machining laser beam;
irradiating a workpiece with the machining laser beam;
emitting an illumination laser beam by output of a plurality of laser elements from a laser array in which the plurality of laser elements are disposed in an array;
illuminating the workpiece with the illumination laser beam emitted by the laser array; and
imaging the workpiece illuminated with the illumination laser beam.
